(19) United States
(12) Patent Application Publication
(10) Pub. No.: US 2007/0022552 A1
(43) Pub. Date: Feb. 1, 2007

(54) Dental hygiene device

(76) Inventor: Marthinus Johannes Scheepers, Polokwane (ZA)

Correspondence Address: HAHN AND MOODLEY, LLP, P.O. BOX 52050, MINNEAPOLIS, MN, 55402, US

(21) Appl. No.: 11/413,923

(22) Filed: Apr. 28, 2006

(30) Foreign Application Priority Data
Jul. 29, 2005 (ZA) 2005/6080

(51) Int. Cl. A46B 9/04

(52) U.S. Cl. 15/167.1; 15/227

(57) ABSTRACT

A dental hygiene device including a finger-receiving portion 12 configured and dimensioned to snugly fit over at least a portion of a finger of a user (not shown) and a handle portion 14 extending from the finger-receiving portion 12, the handle portion 14 being sufficiently long to permit gripping thereof by the hand of the user on which the finger-receiving portion 12 is mounted in use thereby to retain the finger-receiving portion 12 in place. The finger-receiving portion 12 indudes a cleaning pad 16 for cleaning teeth and gums of a person. The pad 16 is fixedly or removably mounted on the finger-receiving portion 12.

### FIELD OF THE INVENTION

This invention relates to dental hygiene devices and, more particularly, to a dental hygiene device which is in part disposable and which is adapted for use by a caretaker of young children, handicapped persons, and the elderly when cleaning the teeth and gums of such persons in their care. It can, however, be used by anyone and also by a person to clean animal's teeth.

### BACKGROUND TO THE INVENTION

Persons who do not possess good motor skills often have difficulties when brushing their teeth using a conventional toothbrush. Due to their lack of refined motor skills, and dentists know that teeth are often not cleaned properly and injuries to gums resulting in ulcers are common. Such problems are especially prevalent amongst young children, handicapped persons, and the elderly.

Even when having their teeth brushed by a caretaker, brushing with a conventional toothbrush easily results in too much pressure being applied to teeth and gums which, especially amongst young children, can lead to an aversion against a daily dental hygiene routine.

The inventor therefore believes that a need exists for a dental hygiene device that permits a caretaker or the person whose teeth are to be cleaned to do so in a relatively non-invasive manner whilst being able to control the pressure applied to teeth and gums during such cleaning better than when using a conventional toothbrush.

### SUMMARY OF THE INVENTION

According to one aspect of the invention, there is provided a dental hygiene device including:-
a finger-receiving portion configured and dimensioned to snugly fit over at least a portion of a finger of a user; and
a handle portion extending from the finger-receiving portion, the handle portion being sufficiently long to permit gripping thereof by the hand of the user on which the finger-receiving portion is mounted in use thereby to retain the finger-receiving portion in place thereby to inhibit accidental swallowing of the device in use, wherein the finger-receiving portion includes a cleaning pad of bristles or a sponge-like layer for cleaning teeth and gums of a person and wherein the pad is removably mounted on the finger-receiving portion.

According to another aspect of the invention, there is provided a dental hygiene device including:-
a finger-receiving portion configured and dimensioned to snugly fit over at least a portion of a finger of a user; and
a handle portion extending from the finger-receiving portion, the handle portion being sufficiently long to permit gripping thereof by the hand of the user on which the finger-receiving portion is mounted in use thereby to retain the finger-receiving portion in place,
in which the device is formed integrally by a moulding process of a single substance and the finger receiving portion blends integrally into the handle portion.

The cleaning pad may be provided with bristles suitable for cleaning teeth and gums. The bristles may be manufactured from rubber or may be conventional nylon bristles as can be found on a conventional toothbrush.

Alternatively, the cleaning pad may be provided with a resiliently deformable sponge-like layer suitable for cleaning teeth and gums.

The bristles or layer may be coated with a flavourant. The flavour may, for example, be mint.

The cleaning pad may be attached to the finger-receiving portion by means of a hook-and-loop arrangement also known as Velcro®.

Alternatively, the cleaning pad may be is attached to the finger-receiving portion by means of an adhesive.

The device may be provided in colours and with images printed thereon which appeal to young children.

The device may be manufactured from any suitable flexible synthetic plastics material or flexible natural rubber.

The finger-receiving portion may in use be fitted onto an index finger of the user.

The user and the person whose teeth and gums are to be cleaned by the device may be the same person.

Alternatively, the user may be a caretaker and the person whose teeth and gums are to be cleaned by the device may be selected from the group including: a young child, a handicapped person, and an elderly person. For example, the device may be used by a mother when cleaning the teeth of her young child.

The device may be provided as part of a kit which kit includes a plurality of cleaning pads.

According to a yet further aspect of the invention, there is provided a dental hygiene device including:-
a glove configured and dimensioned to fit over a hand of a user; and
cleaning pads for cleaning teeth and gums of a person or animal. which pads are fixed or removably mounted on an index finger and a thumb of the glove.

The cleaning pads may be provided with bristles suitable for cleaning teeth and gums. The bristles may be manufactured from rubber or may be conventional nylon bristles as can be found on a conventional toothbrush.

Alternatively, the cleaning pads may be provided with a resiliently deformable sponge-like layer suitable for cleaning teeth and gums.

The bristles or layer may be coated with a flavourant. The flavour may, for example, be mint.

The cleaning pads may be attached to the glove by means of a hook-and-loop arrangement also known as Velcro®.

Alternatively, the cleaning pads may be attached to the glove by means of an adhesive.

The device may be provided in colours and with images printed thereon which appeal to young children.

The glove may be manufactured from any suitable flexible synthetic plastics material or flexible natural rubber.

The user and the person whose teeth and gums are to be cleaned by the device may be the same person.

Alternatively, the user may be a caretaker and the person whose teeth and gums are to be cleaned by the device may be selected from the group including: a young child, a handicapped person, and an elderly person. For example, the device may be used by a mother when cleaning the teeth of her young child.

The device may also be used to clean the teeth and gums of an animal such as, for example, a dog.

The device may be provided as part of a kit which kit includes a plurality of cleaning pads and one glove.

### THE DRAWINGS

The invention will now be described by way of the following non-limiting examples with reference to the accompanying drawings.

In the drawings:-

FIG. 1 is a perspective view of one embodiment of the invention;

FIGS. 2 and 3 are a perspective view of a refinement of the embodiment in FIG. 1, and

FIG. 4 and 5 are a view of another embodiment of the invention.

### DESCRIPTION OF THE PREFERRED EMBODIMENTS OF THE INVENTION

In the drawings, reference numeral 10 generally indicates a dental hygiene device in accordance with the present invention.

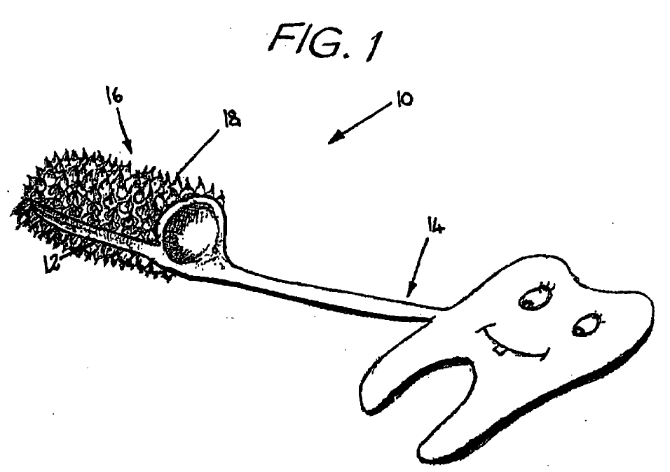

FIG. 1 shows a dental hygiene device including a finger-receiving portion 12 configured and dimensioned to snugly fit over at least a portion of a finger of a user (not shown) and a handle portion 14 extending from the finger-receiving portion 12, the handle portion 14 being sufficiently long to permit gripping thereof by the hand of the user on which the finger-receiving portion 12 is mounted in use thereby to retain the finger-receiving portion 12 in place thereby to inhibit accidental swallowing of the device 10 in use.

The finger-receiving portion 12 includes a cleaning pad 16 for cleaning teeth and gums of a person. The pad 16 is fixedly or removably mounted on the finger-receiving portion 12.

The cleaning pad 16 is provided with bristles 18 suitable for cleaning teeth and gums. The bristles 18 are manufactured from rubber or they can be conventional nylon bristles as can be found on a conventional toothbrush.

The bristles 18 are coated with a flavourant, typically a mint flavour.

The cleaning pad 16 can be attached to the finger-receiving portion 12 by means of a hook-and-loop arrangement also known as Velcroo to permit easy removal of the pad 16 from the device 10.

The device 10 is provided in colours and with images printed thereon which appeal to young children.

The device 10 is manufactured from any suitable flexible synthetic plastics material or flexible natural rubber.

The finger-receiving portion 12 is in use fitted onto an index finger of the user.

The user and the person whose teeth and gums are to be cleaned by the device 10 can be the same person or the user can be a caretaker and the person whose teeth and gums are to be cleaned by the device can be selected from the group including: a young child, a handicapped person, and an elderly person. For example, the device 10 can be used by a mother when cleaning the teeth of her young child.

The device 10 can be provided as part of a kit which kit includes a plurality of cleaning pads 16. In this manner, the device 10 can be re-used and the cleaning pads 16 can be disposed of after use.

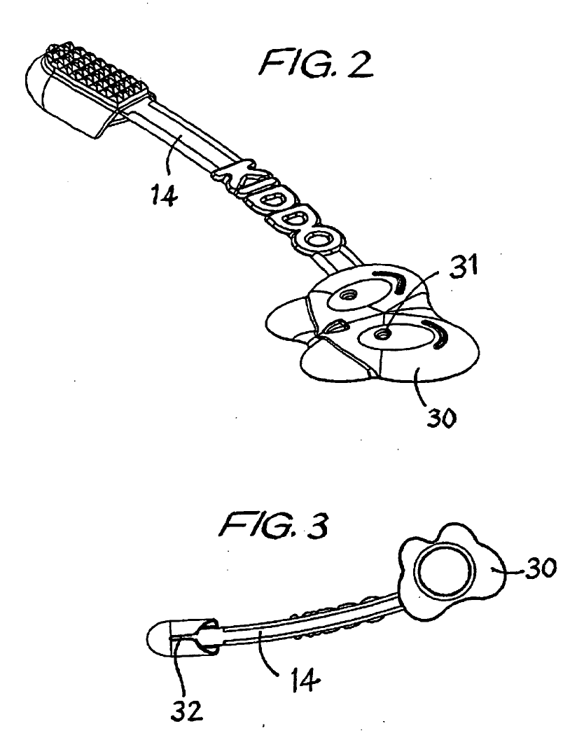

As can be seen from FIG. 1, the device is formed integrally by a moulding process of a single substance; the finger receiving portion blends integrally into the handle portion. The handle portion is a flat strip. i.e. wider than it is thick; it can carry a trade mark in word and/or logo form conveniently by virtue of this flat strip form. Similarly the enlarged portion 30 is formed integrally with the rest of the handle portion 14. The enlarged portion is again essentially flat and this allows a face 31 or other entertaining representation. e.g for appeal top children, to be formed in the moulding process on the enlarged portion of the handle. These features are also well illustrated in FIGS. 2 and 3. FIG. 3 also shows a slot 32 formed in the finger receiving part, which enables this part to enlarge when a big finger is inserted. FIGS. 2 and 3 also show that the handle is curved, this leads the enlarged part of the handle to the centre of the palm of the hand when the index finger is inserted into the finger receiving portion. This curve is suited for right-handed use, a reverse curve could be provided for left-handed use.

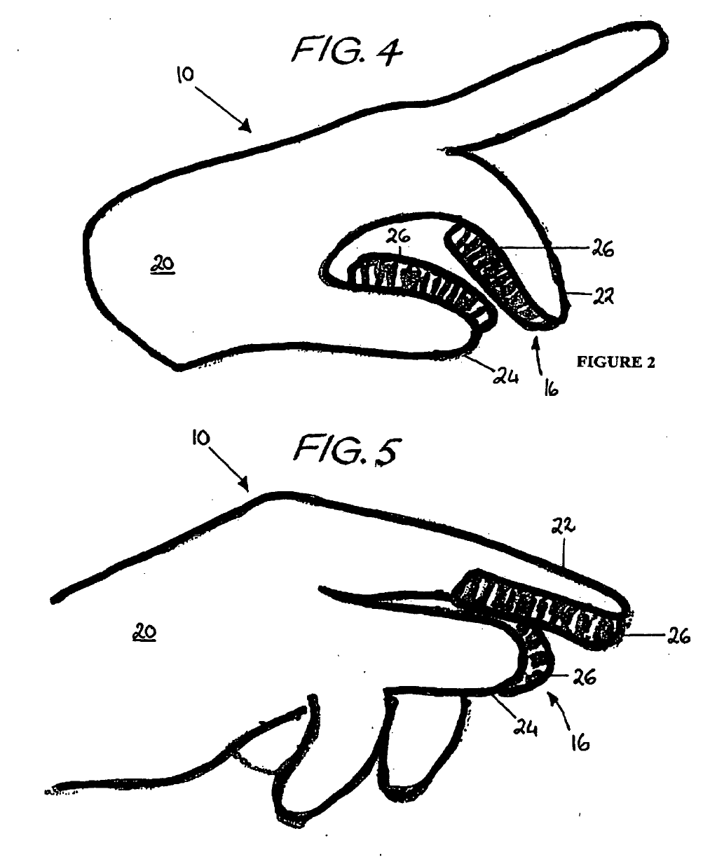

Referring now to FIGS. 4 and 5, there is shown a second embodiment of the present invention. The dental hygiene device 10 includes a glove 20 configured and dimensioned to fit over a hand of a user (not shown) and cleaning pads 16 for cleaning teeth and gums of a person or animal, which pads 16 are fixedly or removably mounted on an index finger 22 and a thumb 24 of the glove 20.

The cleaning pads 16 are provided with a resiliently deformable sponge-like layer 26 suitable for cleaning teeth and gums.

The layer 26 is coated with a mint flavourant.

The cleaning pads 16 are attached to the glove 20 by means of a hook-and-loop arrangement also known as Velcro® to permit easy removal of the pads 16 from the glove 20.

The device 10 is typically provided in colours and with images printed thereon which appeal to young children.

The glove 20 is manufactured from any suitable flexible synthetic plastics material or flexible natural rubber.

The user and the person whose teeth and gums are to be cleaned by the device 10 can be the same person or the user can be a caretaker and the person whose teeth and gums are to be cleaned by the device can be selected from the group including: a young child, a handicapped person, and an elderly person. For example, the device 10 can be used by a mother when cleaning the teeth and gums of her young child.

The device 10 can also be used to clean the teeth and gums of an animal such as, for example, a dog.

The device 10 can provided as part of a kit which kit includes a plurality of cleaning pads 16 and one glove 10.

It is to be appreciated, that the invention is not limited to any specific embodiment or configuration as hereinbefore generally described or illustrated.

1. A dental hygiene device including:-
a finger-receiving portion configured and dimensioned to snugly fit over at least a portion of a finger of a user; and
a handle portion extending from the finger-receiving portion, the handle portion being sufficiently long to permit gripping thereof by the hand of the user on which the finger-receiving portion is mounted in use thereby to retain the finger-receiving portion in place thereby to inhibit accidental swallowing of the device in use, wherein the finger-receiving portion includes a cleaning pad of bristles or a sponge-like layer for cleaning teeth and gums of a person and wherein the pad is removably mounted on the finger-receiving portion.

2. A device as claimed in claim 1, wherein the bristles or layer are coated with a flavourant.

3. A device as claimed in claim 1, wherein the cleaning pad is attached to the finger-receiving portion by means of a hook-and-loop arrangement.

4. A device as claimed in claim 1, wherein the device is provided in colours and with images printed thereon which appeal to young children.

5. A device as claimed in claim 1, wherein the device is manufactured from any suitable flexible synthetic plastics material or flexible natural rubber.

6. A device as claimed in any one of the preceding claims, wherein the device is provided as part of a kit which kit includes a plurality of cleaning pads.

7. A dental hygiene device including:-
a finger-receiving portion configured and dimensioned to snugly fit over at least a portion of a finger of a user; and
a handle portion extending from the finger-receiving portion, the handle portion being sufficiently long to permit gripping thereof by the hand of the user on which the finger-receiving portion is mounted in use thereby to retain the finger-receiving portion in place,
in which the device is formed integrally by a moulding process of a single substance and the finger receiving portion blends integrally into the handle portion.

8. A device as claimed in claim 7, in which the handle portion is a flat strip, i.e. wider than it is thick.

9. A device as claimed in claim 7, in which the handle has an enlarged portion and the enlarged portion is formed integrally with the rest of the handle portion and the enlarged portion is essentially flat.

10. A device as claimed in claim 7, in which the handle is curved.

11. A device as claimed in claim 7, in which the handle carries a trade mark in word andlor logo form and/or a face or other appealing image.

12. A device as daimed in claim 7, in which the finger receiving portion has a slot to facilitate expansion of it.

13. A dental hygiene device including:-
a glove configured and dimensioned to fit over a hand of a user; and
cleaning pads for cleaning teeth and gums of a person or animal, which pads are removably mounted on an index finger and a thumb of the glove.

14. A device as claimed in claim 13, wherein the cleaning pads are provided with bristles suitable for cleaning teeth and gums.

15. A device as claimed in claim 13, wherein the cleaning pads are provided with a resiliently deformable sponge-like layer suitable for cleaning teeth and gums.

16. A device as claimed in claim 14 or claim 15, wherein the bristles or layer are coated with a flavourant.

17. A device as claimed in claim, 13, wherein the cleaning pads are attached to the glove by means of a hook-and-loop arrangement.

18. A device as claimed in claim 13, wherein the cleaning pads are attached to the glove by means of an adhesive.

19. A device as claimed in claim 13, wherein the device is provided in colours and with images printed thereon which appeal to young children.

20. A device as claimed in claim 13, wherein the device is provided as part of a kit which kit includes a plurality of cleaning pads and one glove.
